(19) United States
(12) Patent Application Publication
(10) Pub. No.: US 2026/0155688 A1
(43) Pub. Date: Jun. 4, 2026

(54) ROTOR CONFIGURATION HAVING FLUX BARRIER SHAPE TO IMPROVE INTERIOR PERMANENT MAGNET SYNCHRONOUS MOTOR ROTOR TORQUE PERFORMANCE

(71) Applicants: FCA US LLC, Auburn Hills, MI (US); McMaster University, Hamilton (CA)

(72) Inventors: Dhafar Al-Ani, Auburn Hills, MI (US); Mahmud Ghasemi Bijan, Auburn Hills, MI (US); Ashish Kumar Sahu, Hamilton (CA); Berker Bilgin, Hamilton (CA)

(21) Appl. No.: 18/965,198

(22) Filed: Dec. 2, 2024

(51) Int. Cl. H02K 1/276; B60K 1/00; H02K 21/14

(52) U.S. Cl. CPC H02K 1/276; H02K 21/14; B60K 1/00; B60K 2001/001

(57) ABSTRACT

An electric machine for powering an electric vehicle includes a rotor including rotor laminations and a first magnet. The rotor is configured to rotate relative to a stator to drive a rotor shaft and at least one drive wheel of the electric vehicle. The rotor laminations define a first slot that defines a first flux barrier, a second flux barrier and a first magnet retaining slot portion. The first flux barrier has a first flux barrier width at a first end of the first slot. The second flux barrier has a second flux barrier width at a second end of the fist slot. The first magnet retaining slot portion has a first slot width. The first magnet is positioned in the first magnet retaining slot portion. The first flux barrier width and the second flux barrier width are greater than the first slot width.

### FIELD

The present application relates generally to electric drive modules for electric vehicles and, more particularly, to a rotor configuration having a flux barrier shape that improves permanent magnet synchronous motor rotor torque performance.

### BACKGROUND

Different types of electric vehicles, including mild hybrid electric vehicles (mHEV's), plug-in hybrid electric vehicles (PHEV's), battery electric vehicles (BEV's), and extended-range battery electric vehicles (EREV's), rely on electric machines for propulsion as a main source of torque, which generates the necessary power for vehicle propulsion. An electrical machine that includes a permanent magnet in the interior of the rotor core is called an interior permanent magnet (IPM). The electrical machines is called an interior permanent magnet synchronous motor (IPMSM). An IPMSM provides various advantages, such as high power density and high efficiency in the low and medium speed range. An effective IPMSM design must satisfy electromagnetic performance requirements such as continuous and maximum torque, power density, efficiency, and a wide operating speed range. An IPMSM rotor assembly consists of a shaft, a rotor core which is made of an electric steel lamination stack, and magnets. The magnets are the primary reason for the superior electromagnetic performance of an IPMSM. Magnets need to be uniquely positioned inside the rotor to achieve maximum electromagnetic performance without compromising the structural integrity of the rotor at high-speed applications. It is important to optimize the topology of the rotor to minimize the cost and achieve maximum electromagnetic performance. The flux barriers and bridges play an important role in maximizing electromagnetic performance. The optimum shape of flux barriers and thin bridges reduce flux leakage, and this increases the torque of the motor. However, thin bridges may cause higher stress, leading to structural failure. In this regard, while existing IPMSM configurations can be satisfactory, there remains a need for improvement in the relevant art.

### SUMMARY

In accordance with one example aspect of the invention, an electric machine for powering an electric vehicle includes a rotor including rotor laminations and a first magnet. The rotor is configured to rotate relative to a stator to drive a rotor shaft and at least one drive wheel of the electric vehicle. The rotor laminations define a first slot that defines a first flux barrier, a second flux barrier and a first magnet retaining slot portion. The first flux barrier has a first flux barrier width at a first end of the first slot. The second flux barrier has a second flux barrier width at a second end of the fist slot. The first magnet retaining slot portion has a first slot width. The first magnet is positioned in the first magnet retaining slot portion. The first flux barrier width and the second flux barrier width are greater than the first slot width.

In examples, the first flux barrier of the first slot is tangentially elongated relative to the rotor.

In examples, the second flux barrier of the first slot is elongated.

In other examples, the first flux barrier of the first slot is located proximate an outer perimeter of the rotor.

In other implementations, the rotor lamination includes a first bridge between the outer perimeter and the first flux barrier of the first slot.

In examples, the first flux barrier width and the second flux barrier width of the first slot are greater than the first slot width providing a higher arc radius of the first flux barrier and second flux barrier leading to improved structural integrity.

In other examples, the first flux barrier width and the second flux barrier width of the first slot are greater than the first slot width providing lower flux leakage and improving torque performance of the electric machine.

In additional features, an inductance is created by current applied to the stator, wherein torque is generated due to an inductance difference between a D-axis and a Q-axis owing to the first and second flux barriers of the first slot causing the rotor to be rotated by torque.

In other examples, the rotor lamination of the rotor further defines a second slot that defines a first flux barrier, a second flux barrier and a second magnet. The first flux barrier has a first flux barrier width at a first end of the second slot. The second flux barrier has a second flux barrier width at a second end of the second slot. The second magnet receiving slot portion has a second slot width.

In additional features, the electric machine further comprises a second magnet disposed in the second magnet receiving slot portion, wherein the first flux barrier width and the second flux barrier width of the second slot are greater than the second slot width.

In additional examples, the first flux barrier of the second slot is tangentially elongated relative to the rotor.

In other examples, the second flux barrier of the second slot is elongated.

In additional features, the first flux barrier of the second slot is located proximate an outer perimeter of the rotor.

In other examples, the rotor lamination includes a second bridge between the outer perimeter and the first flux barrier of the second slot.

In other features, the first flux barrier width and the second flux barrier width of the second slot are greater than the second slot width, providing a higher arc radius of the first flux barrier of the second slot, leading to improved structural integrity.

In additional examples, the first flux barrier width and the second flux barrier width of the second slot are greater than the second slot width providing lower flux leakage and improving torque performance of the electric machine.

In other examples, an inductance is created by current applied to the stator, wherein torque is generated due to an inductance difference between a D-axis and a Q-axis owing to the first and second flux barriers of the second slot causing the rotor to be rotated by torque.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a schematic illustration of an example electric vehicle drivetrain having an electric drive module that incorporates an interior permanent magnet synchronous motor (IPMSM) constructed in accordance with the principles of the present application;

FIG. 2 is a rotor laminations stack and magnet assembly used in an IPMSM in accordance with one prior art example;

FIG. 3 is a detail view of a rotor lamination of the rotor laminations stack and magnet assembly of FIG. 2 showing flux barriers and bridges, in accordance with one prior art example;

FIG. 4 is a detail view of a rotor lamination of the IPMSM having a flux barrier shape in accordance with the principles of the present application;

FIG. 5 is a close-up detail view of a portion of the rotor lamination of FIG. 4 and shown with exemplary dimensions including a magnet slot, width of flux barrier, thickness of bridge, arc radius of flux barrier in accordance with the principles of the present application;

FIG. 6 is a detail view of a rotor lamination of the IPMSM shown with magnets and having a flux barrier shape in accordance with the principles of the present application; and

FIG. 7 is a detail view of a rotor lamination shown with a complementary stator and illustrating exemplary flux lines according to feature of the present application.

### DETAILED DESCRIPTION

As noted above, electric machines are used in various types of electrified vehicles to generate the necessary power for vehicle propulsion. Electrical machines include rotor laminations stack that incorporates magnets disposed within slots defined in the rotor lamination stacks. An effective IPMSM design must satisfy electromagnetic performance requirements such as continuous and maximum torque, power density, efficiency, and a wide operating speed range. An IPMSM rotor assembly consists of the shaft, rotor electric steel laminations stack, and magnets. The magnets are the primary reason for the superior electromagnetic performance of an IPMSM. Magnets need to be uniquely positioned inside the rotor to achieve maximum electromagnetic performance without affecting the structural integrity of the rotor at high-speed applications. It is important to optimize the topology of the rotor in order to minimize the cost and achieve maximum electromagnetic performance. The flux barriers and bridges play an important role in maximizing electromagnetic performance. The optimum shape of flux barriers and thin bridges reduce flux leakage, and this increases the torque of the motor. However, thin bridges may cause higher stress, leading to structural failure.

The present disclosure provides a rotor lamination of the IPMSM having an improved flux barrier shape. The unique flux barrier shapes are suitable for a Double V magnet configuration in an IPMSM. The flux barriers are wider than the width of the magnet slot and spread on both sides of the magnet slot. The larger width of the flux barriers provides an opportunity to have a higher arc radius for the flux barrier. The higher arc radius leads to lower stress concentration and thus the magnets can be pushed closer to the outer radius of the rotor with a lower thickness of the bridge, which is favorable for higher torque production. Additionally, the larger width of the flux barriers as compared to the magnet slot width leads to lower flux leakage leading to improved torque performance. In this regard, it leads to higher torque density and is suitable for high-speed applications.

In other prior arrangements, flux barrier shapes are typically radially elongated. The flux barrier shape of the present disclosure is tangentially elongated making it wider than the width of the magnet slot. A wider flux barrier provides an opportunity to reduce stress with a higher radius of the flux barrier and to keep the magnet closer to the outer diameter. The flux barrier for outer magnets is tilted toward the d-axis flux path to reduce the leakage flux and improve electromagnetic performance.

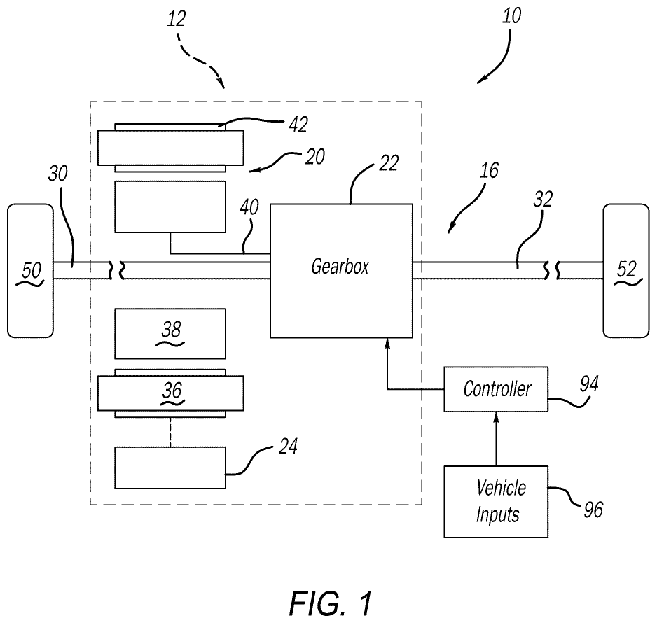

With initial reference to FIG. 1, a vehicle 10 is partially shown in accordance with the principles of the present disclosure. In the example embodiment, vehicle 10 includes an electric drive module (EDM) 12 configured to generate and transfer drive torque to a driveline 16 for vehicle propulsion. The EDM 12 generally includes one or more electric drive units or machines 20 (e.g., electric traction machines), a gearbox assembly 22, and power electronics including a power inverter module (PIM) 24. The electric machine 20 is selectively connectable via the PIM 24 to a high voltage battery system (not shown) for powering the electric machine 20. The gearbox assembly 22 is configured to transfer the generated drive torque to the driveline 16, including a first or left axle shaft 30 and a second or right axle shaft 32. In the example shown, the EDM 12 is configured for use on a rear axle of a two-wheel drive vehicle. It is appreciated however that the EDM 12 can be alternatively configured for use on a front axle of a two-wheel drive vehicle. In other examples an EDM 12 can be provided on both of the front and rear axles for a four-wheel drive or all-wheel drive driveline vehicle.

In the example embodiment, the electric machine 20 generally includes a stator 36, a rotor 38, and a rotor output shaft 40. The stator 36 is fixed (e.g., to a housing 42) and the rotor 38 is configured to rotate relative to the stator 36 to drive the rotor shaft 40 and thus the vehicle axles 30, 32 (e.g., half shafts) and therefore respective drive wheels 50, 52. In the illustrated example, the EDM 12 is configured for a rear axle (axles 30, 32) of the vehicle 10, but it will be appreciated that the systems and methods described herein are equally applicable to a front axle EDM configuration, and can be replicated on the front and rear axles for four wheel drive. In examples, the vehicle can include a controller 94 that receives vehicle inputs 96. The controller 94 can communicate signals to the gearbox 22 for operating the EDM according to various driver requested modes and/or alter an operating condition based on sensed vehicle parameters.

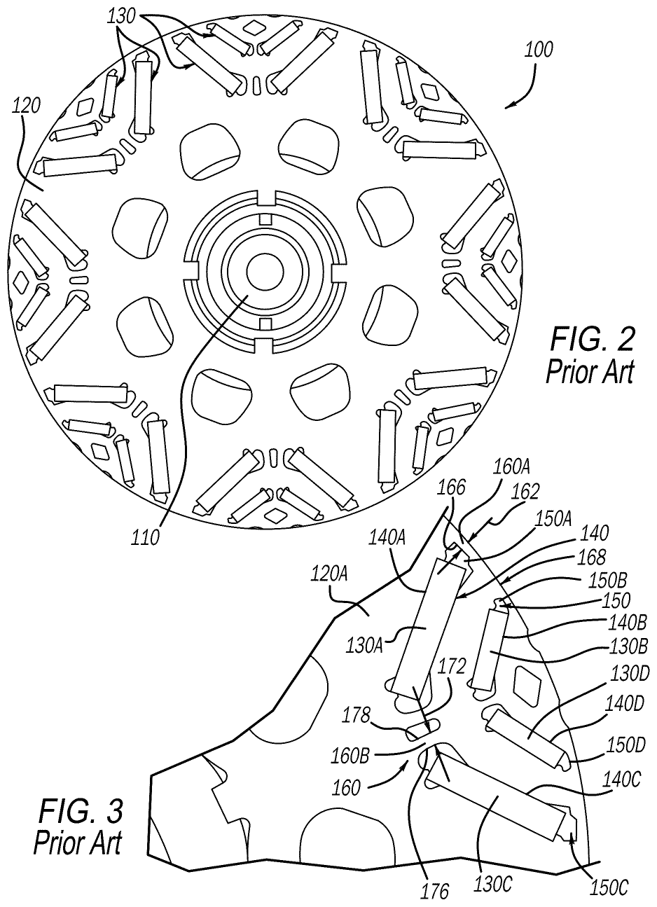

With reference now to FIG. 2, a rotor laminations stack and magnet assembly used in the electric machine of the electric drive module shown in FIG. 1 according to one Prior Art example is generally identified at reference numeral 100. The exemplary rotor laminations stack and magnet assembly 100 can include a shaft 110, a rotor electric steel lamination stack 120, and a plurality of magnets, collectively identified at reference numeral 130.

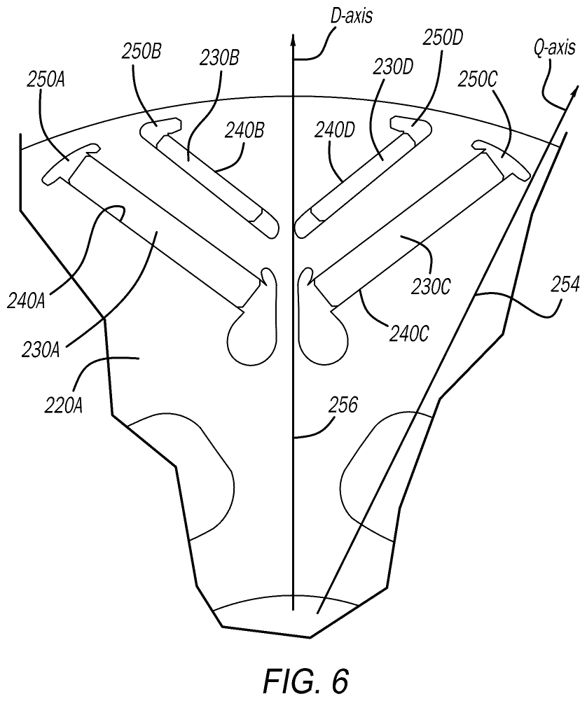

A rotor lamination 120A of the rotor electric steel laminations stack 120 generally defines various pockets or slots, collectively identified at 140 and individually identified at reference 140A, 140B, 140C, 140D, etc. configured to receive the complementary magnets 130A, 130B, 130C, 130D, etc. The rotor includes a plurality of flux barriers, collectively identified at reference numeral 150 and individually identified at reference 150A, 150B, 150C and 150D. The plurality of flux barriers 150 are made of a non-magnetic substance (air is filled inside the flux barriers) radially arranged having the Q-axis as a center and the D-axis as a boundary (further explained at FIG. 6).

In general, an inductance can be created by current applied to the stator 36. Torque is generated due to an inductance difference between the D-axis and the Q-axis owing to the flux barrier causing the rotor shaft 110 to be rotated by torque. The rotor lamination 120A further includes bridges, collectively identified at reference 160 and individually identified at reference 160A and 160B. The bridge 160A can have a bridge thickness 162 defined between a slot boundary 166 and a rotor lamination perimeter 168. The bridge 160B can have a bridge thickness 172 defined between a slot boundary 176 and pocket boundary 178.

As mentioned above, it is important to optimize the topology of the rotor lamination 120A to minimize the cost and achieve maximum electromagnetic performance. The flux barriers 150 and bridges 160 play an important role in maximizing electromagnetic performance. The optimum shape of flux barriers 150 and thin bridges 160 reduce flux leakage, and this increases the torque of the motor. However, thin bridges 160 may cause higher stress, leading to structural failure.

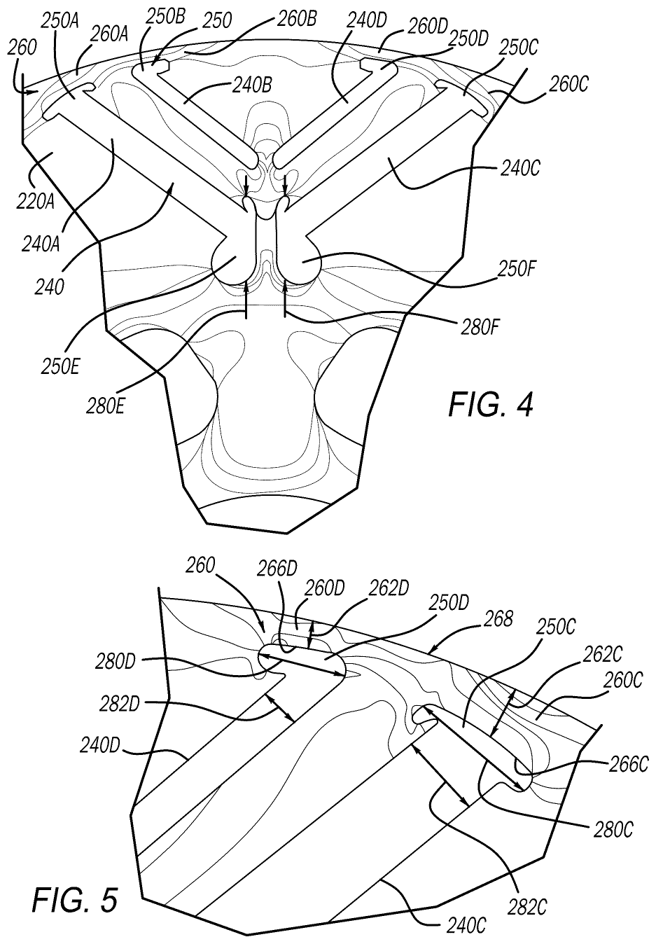

With reference now to FIGS. 4-6, a rotor lamination 220A of a rotor laminations stack constructed in accordance to one example of the present disclosure will be described. The rotor lamination 220A can be used in place of the rotor lamination stack and magnet assembly 100 shown in FIG. 2 and generally in the electric machine 20 of FIG. 1. The rotor lamination 220A generally defines various pockets or slots, collectively identified at 240 and individually identified at reference 240A, 240B, 240C, 240D, etc. configured to receive the complementary magnets 230A, 230B, 230C, 230D, etc. (FIG. 6). As used herein, the rotor lamination 220A can have a plurality of slots configured similar to the slot 240A and 240C. In this regard, the slot 240A can be referred to herein as a first slot while the slot 240C can be referred to herein as a second slot. Similarly, the rotor lamination 220A can have a plurality of slots configured similar to the slot 240B and 240D.

The rotor lamination 220A includes a plurality of flux barriers, collectively identified at reference numeral 250 and individually identified at reference 250A, 250B, 250C, 250D, 250E and 250F. As is known, two axes are identified for controlling a motor. A first axis, identified as a D-axis is used as a boundary of a magnetic pole. A second axis, identified as a Q-axis is a center of the magnetic pole. The D-axis provides a high magnetic permeability while the Q-axis has a low magnetic permeability. Due to an inductance difference between the D-axis and the Q-axis, a torque is generated. The plurality of flux barriers 250 are made of a non-magnetic substance radially arranged having a Q-axis 254 as a center and a D-axis 256 as a boundary (FIG. 6).

In general, an inductance can be created by current applied to the stator 36. Torque is generated due to an inductance difference between the D-axis 256 and the Q-axis 254 owing to the flux barrier 250 causing the rotor shaft 110 to be rotated by torque. The rotor lamination 220A further includes bridges, collectively identified at reference 260 and individually identified at reference 260A, 260B, 260C and 260D. The bridge 260C can have a bridge thickness 262C defined between a slot boundary 266C and a rotor lamination perimeter 268. The bridge 260D can have a bridge thickness 262D defined between a slot boundary 266D and the rotor lamination perimeter 268.

The flux barrier 250C defines a flux barrier width 280C. The slot 282C that receives the magnet 230C defines a slot width 282C. The flux barrier width 280C is greater than the slot width 282C. The flux barrier 250D defines a flux barrier width 280D. The slot 282D that receives the magnet 230D defines a slot width 282D. The flux barrier width 280D is greater than the slot width 282D. The flux barrier 250E defines a flux barrier width 280E. The flux barrier 250F defines a flux barrier width 280F. The flux barrier width 280F is greater than the slot width 282C.

By way of example, the flux barriers 250C and 250F are both wider than the width 282C of the magnet slot 240C and spread on both sides of the magnet slot 240C. The larger width of the flux barriers 250C and 250F provides a higher arc radius of the flux barrier. The higher arc radius leads to lower stress concentration and therefore, the magnets 230 can be pushed closer to the outer radius of the rotor 220A with a lower thickness 262C of the bridge 260C, which is favorable for higher torque production. Furthermore, the larger width of the flux barriers 250C and 250F as compared to the magnet slot width 282C leads to lower flux leakage leading to improved torque performance. As a result, the instant configuration leads to higher torque density and is suitable for high-speed applications.

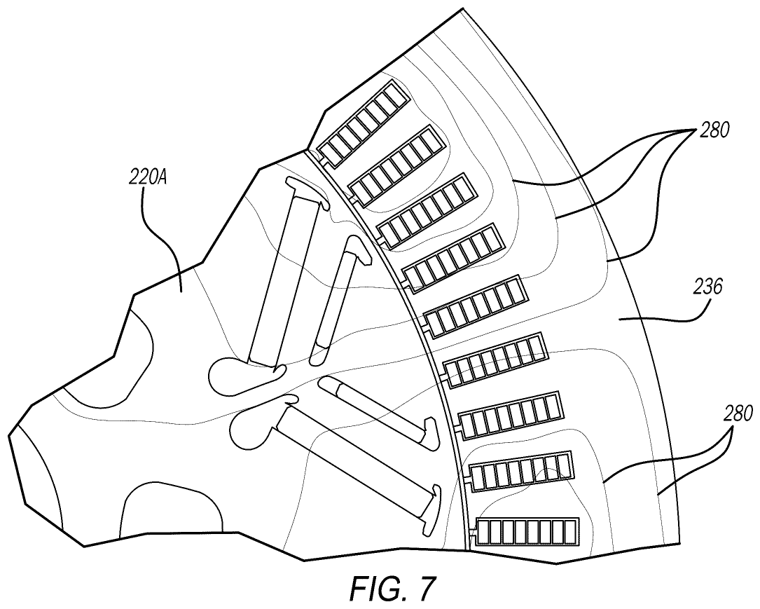

FIG. 7 is a detail view of a rotor lamination 220A shown with a complementary stator 236 and illustrating exemplary flux lines 280 according to feature of the present application.

It will be appreciated that the term “controller” or “module” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. An electric machine for powering an electric vehicle, the electric machine comprising:
a rotor configured to rotate relative to a stator to drive a rotor shaft and at least one drive wheel of the electric vehicle;
a rotor lamination of the rotor defining a first slot that defines:
a first flux barrier having a first flux barrier width at a first end of the first slot;
a second flux barrier having a second flux barrier width at a second end of the first slot; and
a first magnet retaining slot portion having a first slot width; and
a first magnet positioned in the first magnet retaining slot portion, wherein the first flux barrier width and the second flux barrier width are greater than the first slot width.

2. The electric machine of claim 1, wherein the first flux barrier of the first slot is tangentially elongated relative to the rotor.

3. The electric machine of claim 1, wherein the second flux barrier of the first slot is elongated.

4. The electric machine of claim 1, wherein the first flux barrier of the first slot is located proximate an outer perimeter of the rotor.

5. The electric machine of claim 4, wherein the rotor lamination includes a first bridge between the outer perimeter and the first flux barrier of the first slot.

6. The electric machine of claim 1, wherein the first flux barrier width and the second flux barrier width of the first slot are greater than the first slot width providing a higher arc radius of the first flux barrier.

7. The electric machine of claim 6, wherein the first flux barrier width and the second flux barrier width of the first slot are greater than the first slot width providing lower flux leakage and improving torque performance of the electric machine.

8. The electric machine of claim 1, wherein an inductance is created by current applied to the stator, wherein torque is generated due to an inductance difference between a D-axis and a Q-axis owing to the first and second flux barriers of the first slot causing the rotor to be rotated by torque.

9. The electric machine of claim 1, wherein the rotor lamination of the rotor further defines a second slot that defines:
a first flux barrier having a first flux barrier width at a first end of the second slot;
a second flux barrier having a second flux barrier width at a second end of the second slot; and
a second magnet receiving slot portion having a second slot width.

10. The electric machine of claim 9, further comprising a second magnet disposed in the second magnet receiving slot portion, wherein the first flux barrier width and the second flux barrier width of the second slot are greater than the second slot width.

11. The electric machine of claim 10, wherein the first flux barrier of the second slot is tangentially elongated relative to the rotor.

12. The electric machine of claim 10, wherein the second flux barrier of the second slot is elongated.

13. The electric machine of claim 10, wherein the first flux barrier of the second slot is located proximate an outer perimeter of the rotor.

14. The electric machine of claim 13, wherein the rotor lamination includes a second bridge between the outer perimeter and the first flux barrier of the second slot.

15. The electric machine of claim 10, wherein the first flux barrier width and the second flux barrier width of the second slot are greater than the second slot width providing a higher arc radius of the first flux barrier of the second slot.

16. The electric machine of claim 15, wherein the first flux barrier width and the second flux barrier width of the second slot are greater than the second slot width providing lower flux leakage and improving torque performance of the electric machine.

17. The electric machine of claim 10, wherein an inductance is created by current applied to the stator, wherein torque is generated due to an inductance difference between a D-axis and a Q-axis owing to the first and second flux barriers of the second slot causing the rotor to be rotated by torque.
